(19) United States
(12) Patent Application Publication
(10) Pub. No.: US 2024/0315464 A1
(43) Pub. Date: Sep. 26, 2024

(54) ELASTIC UNIT, ELASTIC ASSEMBLY, AND ELASTIC MATTRESS

(71) Applicant: New-Tec Integration (Xiamen) Co., Ltd., Xiamen City (CN)

(72) Inventor: Luhao LENG, Xiamen City (CN)

(21) Appl. No.: 18/141,095

(22) Filed: Apr. 28, 2023

(30) Foreign Application Priority Data
Mar. 23, 2023 (CN) 202310290019.3

(51) Int. Cl. A47C 27/06

(52) U.S. Cl. CPC A47C 27/064

(57) ABSTRACT

An elastic unit, an elastic assembly, and an elastic mattress are provided. The elastic unit comprises a base comprising a first end and a second end opposite to the first end in a length direction of the base and a plurality of elastic modules disposed between the first end and the second end of the base. The plurality of elastic modules are detachably disposed on the base, and the elastic unit comprises at least one bottom opening to enable at least one of the plurality of elastic modules to be sleeved on an upper surface of at least one of a plurality of elastic modules of another one elastic unit.

### RELATED APPLICATIONS

This application claims priority to Chinese patent application number 202310290019.3, filed on Mar. 23, 2023. Chinese patent application number 202310290019.3 is incorporated herein by reference.

### FIELD OF THE DISCLOSURE

The present disclosure relates to the field of furniture, and in particular to an elastic unit, an elastic assembly, and an elastic mattress.

### BACKGROUND OF THE DISCLOSURE

Furniture, such as spring beds and sofa beds, is an indispensable part of people's lives. Most of the existing beds and sofa beds are provided with an elastic mattress. The elastic mattress has a certain degree of elasticity. When people lie on a bed or a sofa bed, the elastic mattress can provide a certain amount of elastic support and has a certain degree of comfort compared to a hard mattress.

Existing elastic mattresses are usually an integrated, non-detachable, and closed structure formed by a bottom layer, a spring layer, a sponge superimposed layer, and a closed side wall. That is, the spring layer is disposed on the bottom layer, and the sponge superimposed layer is disposed on the spring layer. The closed side wall is connected to the sponge superimposed layer and the bottom layer to form a closed space. However, in actual use, such an elastic mattress is complicated to assemble, has poor stability, is not convenient to carry, and takes up a large space when stored.

### BRIEF SUMMARY OF THE DISCLOSURE

The present disclosure provides an elastic unit, an elastic assembly, and an elastic mattress to solve the deficiencies of complex assembly and poor stability of the elastic mattress in the background.

In order to solve the technical problem, a first technical solution of the present disclosure is as follows.

An elastic unit comprises a base comprising a first end and a second end opposite to the first end in a length direction of the base and a plurality of elastic modules disposed between the first end and the second end of the base. The plurality of elastic modules are detachably disposed on the base, and The elastic unit comprises at least one bottom opening to enable at least one of the plurality of elastic modules to be sleeved on an upper surface of at least one of a plurality of elastic modules of another elastic unit.

In this embodiment, since the plurality of elastic modules are detachably disposed on the base, the plurality of elastic modules can be arranged in a relatively orderly manner. The elastic unit comprises the at least one bottom opening located at a position at which at least one of the plurality of elastic modules is disposed, which can make the at least one of the plurality of elastic modules be configured to be sleeved on at least one of the plurality of elastic modules of another one of the elastic units, so that the plurality of elastic modules are configured to be respectively sleeved on the plurality of elastic modules of another one of the elastic units, or to be sleeved on two of the plurality of elastic modules of another one of the elastic units at two ends of the another one of the elastic units, so as to achieve rapid assembly of the elastic units and make a whole structure have more excellent stability. Furthermore, after the elastic units are detached from one another, the elastic units 1 can also be stacked in a sleeved manner, which can effectively facilitate disassembly and transportation of an elastic mattress and reduce a space occupied by storage.

In preferred embodiment, each of the plurality of elastic modules comprises a spring and a flexible sleeve. The flexible sleeve comprises a closed end and an open end defining the at least one bottom opening. The spring is configured to pass through the open end of the flexible sleeve to enter an inside of the flexible sleeve to enable the flexible sleeve to be wrapped around an outside of the spring. The open end of the flexible sleeve is configured to be detachably connected to a bottom end of the spring to enable the spring to have a predetermined initial elastic force by compression, and the open end is configured to receive a top part of the at least one of the plurality of elastic modules of the another elastic unit to form sleeving of two elastic modules which belong to different elastic units.

In preferred embodiment, a thickness of the base is 5-20 mm, and a distance between two adjacent elastic modules of the plurality of the elastic modules is 2-10 mm.

In preferred embodiment, the spring is a conical spring.

In preferred embodiment, the spring comprises an upper part and a lower part, the upper part is spherical, and the lower part is conical.

A second technical solution of the present disclosure is as follows.

An elastic assembly comprises two installation units and a plurality of elastic units. The two installation units are placed symmetrically parallel to each other, and each of the two installation units comprises a positioning base. The positioning base comprises a first end and a second end opposite to the first end in a length direction of the positioning base. Each of the two installation units comprises a plurality of positioning assemblies disposed at intervals between the first end of the positioning base and the second end of the positioning base. A number of the elastic units is less than or equal to a number of the plurality of positioning assemblies of each of the two installation units. Each of the plurality of elastic units comprises a base, and the base comprises a first end and a second end opposite to the first end in a length direction of the base. Each of the plurality of elastic units comprises a plurality of elastic modules disposed between the first end of the base and the second end of the base. The plurality of elastic modules are detachably disposed on the base, and each of the plurality of elastic units comprises at least one bottom opening to enable at least one of the plurality of elastic modules to be sleeved on an upper surface of at least one of the plurality of positioning assemblies of a corresponding one of the two installation units.

In preferred embodiment, each of the plurality of elastic modules comprises a spring and a flexible sleeve. The flexible sleeve comprises a closed end and an open end defining the at least one bottom opening. The spring is configured to pass through the open end of the flexible sleeve to enter an inside of the flexible sleeve to enable the flexible sleeve to be wrapped around an outside of the spring. The open end of the flexible sleeve is configured to be detachably connected to a bottom end of the spring to enable the spring to have a predetermined initial elastic force by compression, and the open end is configured to receive a top part of the at least one of the plurality of positioning assemblies of a corresponding one of the two installation units.

In preferred embodiment, the spring is a conical spring.

In preferred embodiment, the spring comprises an upper part and a lower part, the upper part is spherical, and the lower part is conical.

A third technical solution of the present disclosure is as follows.

An elastic assembly comprises two first elastic units and a plurality of second elastic units. The two first elastic units are configured to be placed symmetrically parallel to each other. Each of the two first elastic units comprising a first base, and the first base comprises a first end and a second end opposite to the first end in a length direction of the first base. Each of the two first elastic units comprises a plurality of first elastic modules disposed between the first end of the first base and the second end of the first base. The plurality of second elastic units comprises a second base, and the second base comprises a first end and a second end opposite to the first end in a length direction of the second base. Each of the plurality of second elastic units comprises a plurality of second elastic modules disposed between the first end of the second base and the second end of the second base. The plurality of the second elastic modules are detachably connected to the second base. Each of the plurality of second elastic units comprises at least one bottom opening to enable at least one of the plurality of the second elastic modules to be sleeved on an upper surface of at least one of the plurality of first elastic modules of a corresponding one of the two first elastic units. A number of the plurality of second elastic units is less than or equal to a number of the plurality of first elastic modules.

In a preferred embodiment, each of the plurality of first elastic modules comprises a first spring and a first flexible sleeve. The first flexible sleeve has a first closed end and a first open end, and the first spring is configured to pass through the first open end of the first flexible sleeve to enter an inside of the first flexible sleeve to enable the first flexible sleeve to be wrapped around an outside of the first spring. The first open end of the first flexible sleeve is configured to be detachably connected to a bottom end of the first spring, so that the first spring has a predetermined initial elastic force by compression.

Each of the plurality of the second elastic modules comprises a second spring and a second flexible sleeve. The second flexible sleeve has a second closed end and a second open end. The second spring is configured to pass through the second flexible sleeve to enter an inside of the second flexible sleeve so as to enable the second flexible sleeve to be wrapped around an outside of the second spring, and the second open end of the second flexible sleeve is configured to be detachably connected to a bottom end of the second spring, so that the second spring has a predetermined initial elastic force by compression. The second open end can receive a top part of one of the plurality of first elastic modules to form sleeving of the two.

In a preferred embodiment, a first one of the plurality of second elastic modules adjacent to the first end of the second base and a second one of the plurality of second elastic modules adjacent to the second end of the second base are respectively sleeved on a first one of the plurality of first elastic modules belonging to a first one of the two first elastic units and a second one of the plurality of first elastic modules belonging to a second one of the two first elastic units and opposite to the first one of the plurality of first elastic modules belonging to the first one of the two first elastic units, so as to enable the plurality of second elastic units to be sleeved on the two first elastic units.

In preferred embodiment, the spring is a conical spring.

A fourth technical solution of the present disclosure is as follows.

An elastic mattress configured for furniture comprises one or more of the elastic units.

A fifth technical solution of the present disclosure is as follows.

An elastic mattress configured for furniture comprises one or more of the elastic assemblies, a bottom mattress is disposed below the one or more of the elastic assemblies, and an outer cover covers an outer surface of the one or more of the elastic assemblies.

Additional features and advantages of the present disclosure will be set forth in the description which follows, and in part will be apparent from the description, or may be learned by practice of the disclosure. The objectives and other beneficial effects of the present disclosure can be realized and obtained by the structures particularly pointed out in the specification, claims, and accompanying drawings.

### BRIEF DESCRIPTION OF THE DRAWINGS

In order to more clearly illustrate the technical solutions in the embodiments of the present disclosure or the prior art, the following will briefly introduce the drawings that need to be used in the description of the embodiments or the prior art. Obviously, the accompanying drawings in the following description are some embodiments of the present disclosure. For those of ordinary skill in the art, other drawings can also be obtained from these drawings without creative work. The positional relationship described in the drawings in the following description, unless otherwise specified, is the orientation of the components shown in the figure for reference.

FIG. 1 illustrates a perspective view of an elastic unit in embodiment 1 of the present disclosure.

FIG. 2 illustrates a side view of the elastic unit in embodiment 1 of the present disclosure.

FIG. 2A illustrates an enlarged encircled position A in FIG. 2.

FIG. 3 illustrates a bottom view of the elastic unit in Embodiment 1 of the present disclosure.

FIG. 4 illustrates a side view of an elastic module in Embodiment 1 of the present disclosure.

FIG. 5 illustrates a side view of the elastic module with a right part of a flexible sleeve removed in Embodiment 1 of the present disclosure.

FIG. 6 illustrates a side view of another type of the elastic module with a right part of a flexible sleeve removed in Embodiment 1 of the present disclosure.

FIG. 7 illustrates a perspective view of an elastic assembly in Embodiment 2 of the present disclosure.

FIG. 8 illustrates a perspective view of the elastic assembly, which is being assembled in Embodiment 2 of the present disclosure.

FIG. 9 illustrates a perspective view of the elastic assembly, which has been assembled in Embodiment 2 of the present disclosure.

FIG. 10 illustrates a bottom view of the elastic assembly, which has been assembled in Embodiment 2 of the present disclosure.

FIG. 11 illustrates a perspective view of an elastic assembly in Embodiment 3 of the present disclosure.

FIG. 12 illustrates a perspective view of an elastic mattress in an assembly process in Embodiment 5 of the present disclosure.

FIG. 13 illustrates a perspective view of an elastic mattress in an assembly process in Embodiment 6 of the present disclosure.

### DETAILED DESCRIPTION OF THE EMBODIMENTS

The present disclosure will be further described below in combination with the accompanying drawings and embodiments.

In order to make the purpose, technical solutions, and advantages of the embodiments of the present disclosure clearer, the technical solutions in the embodiments of the present disclosure will be clearly and completely described below in conjunction with the drawings in the embodiments of the present disclosure. Obviously, the described embodiments are a part of the embodiments of the present disclosure, rather than all embodiments. The technical features designed in the different embodiments of the present disclosure described below can be combined as long as they do not constitute conflicts. Based on the embodiments of the present disclosure, all other embodiments obtained by persons of ordinary skill in the art without creative efforts fall within the protection scope of the present disclosure.

In the description of the present disclosure, it should be noted that all the terms (including technical terms and scientific terms) used in the present disclosure have the same meanings as commonly understood by those of ordinary skill in the art to which the present disclosure belongs and should not be construed limitations of the disclosure. It should be further understood that the terms used in the present disclosure should be understood to have a meaning consistent with the meaning of these terms in the context of this specification and in the relevant field and should not be interpreted in an idealized or overly formal sense, unless explicitly so defined in the present disclosure.

### Embodiment 1

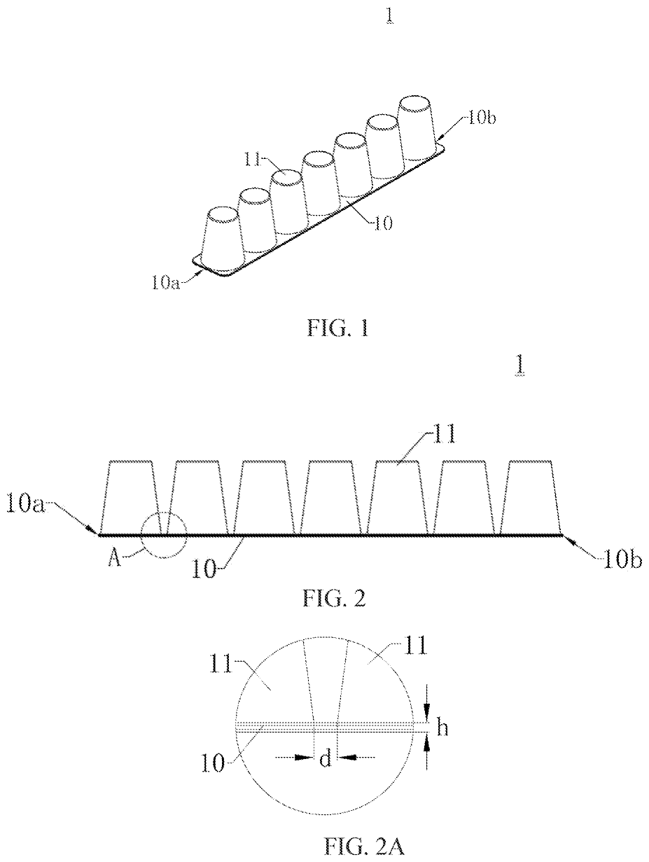

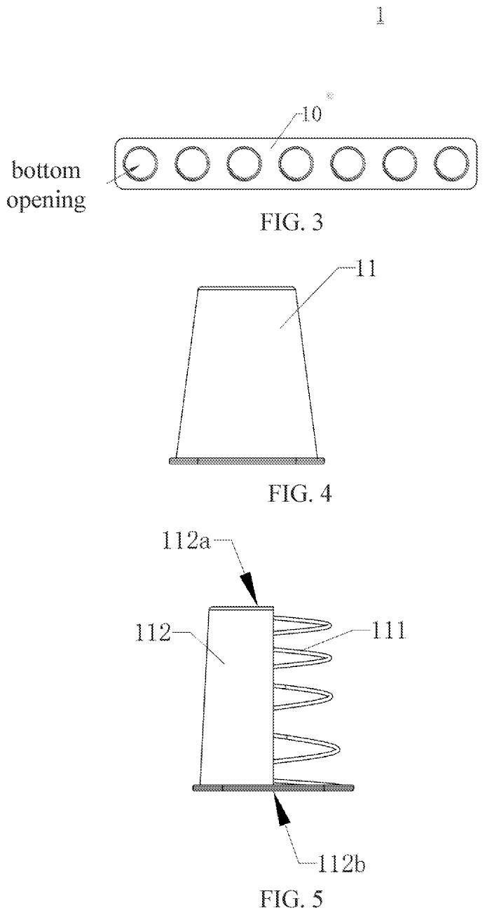

Referring to FIGS. 1 to 3, an elastic unit 1 of Embodiment 1 of the present disclosure is provided, and the elastic unit 1 comprises: a base 10 and a plurality of elastic modules 11. The base 10 comprises a first end 10a and a second end 10b opposite to the first end 10a in a length direction of the base 10, and the plurality of elastic modules 11 are disposed between the first end 10a and the second end 10b.

The plurality of elastic modules 11 are detachably disposed on the base 10, and the elastic unit 1 comprises at least one bottom opening to enable at least one of the plurality of elastic modules 11 to be sleeved on an upper surface of at least one of the plurality of elastic modules 11 of another one of the elastic units 1.

In this embodiment, since the plurality of elastic modules 11 are detachably disposed on the base 10, the plurality of elastic modules 11 can be arranged in a relatively orderly manner. The elastic unit 1 comprises the at least one bottom opening located at a position at which at least one of the plurality of elastic modules 11 is disposed, which can make the at least one of the plurality of elastic modules 11 be configured to be sleeved on at least one of the plurality of elastic modules of another one of the elastic units, so that the plurality of elastic modules 11 are configured to be respectively sleeved on the plurality of elastic modules of another one of the elastic units, or to be sleeved on two of the plurality of elastic modules of another one of the elastic units at two ends of the another one of the elastic units, so as to achieve rapid assembly of the elastic units and make a whole structure have more excellent stability. Furthermore, after the elastic units 1 are detached from one another, the elastic units 1 can also be stacked in a sleeved manner, which can effectively facilitate disassembly and transportation of an elastic mattress and reduce a space occupied by storage.

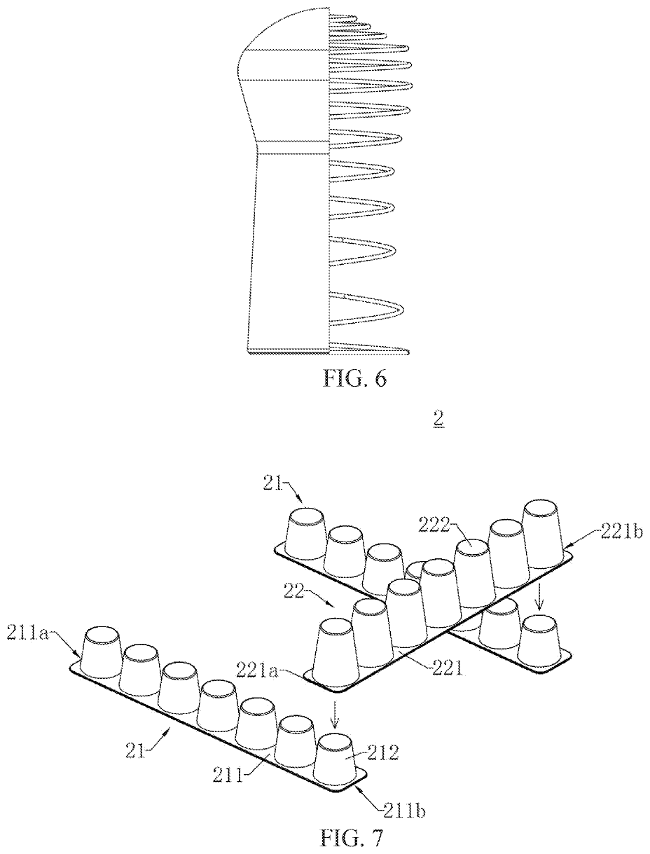

In one or more embodiments of the present disclosure, referring to FIG. 4 and FIG. 5, each of the plurality of elastic modules 11 comprises a spring 111 and a flexible sleeve 112. The flexible sleeve 112 comprises a closed end 112a and an open end 112b, and the spring 111 is configured to pass through the open end 112b of the flexible sleeve 112 to enter an inside of the flexible sleeve 112 to enable the flexible sleeve 112 to be wrapped around an outside of the spring 111. The open end 112b of the flexible sleeve 112 is configured to be detachably connected to a bottom end of the spring 111 to enable the spring 111 to have a predetermined initial elastic force by compression. The open end 112b can receive a top part of another one of the plurality of elastic modules to form sleeving of two elastic modules which belong to different elastic units. Since each of the plurality of elastic modules 11 has the flexible sleeve 112 located outside of the spring 111, no matter whether the plurality of elastic modules 11 are in a state of being assembled into the elastic mattress or in a state of forming a stacked structure, the spring 111 in one of the plurality of elastic modules 11 is not easily entangled with the spring 111 or other components in another adjacent one of the plurality of elastic modules 11. Compared with a single spring not disposed in the flexible sleeve 112, since the plurality of elastic modules 11 are disposed on the base 10, a force-bearing area of the plurality of elastic modules 11 is larger and more stable, and the elastic mattress is more stable during use. According to needs, an elastic force of the spring 111 by compression in the flexible sleeve 12 can be adjusted, thereby pre-obtaining an initial pressure acting on the spring 111 in the plurality of elastic modules 11, so that each of the plurality of elastic modules 11 can have a required rigidity, and the plurality of elastic modules 11 with different rigidities can also be set at different positions of the elastic mattress as required. The plurality of elastic modules 11 in the elastic mattress can realize compression movement and release movement independently of one another in a true sense. In addition, the flexible sleeve 12 can also play a certain degree of position-limiting effect on the spring 111, preventing the spring 111 from randomly shaking in a horizontal direction relative to the base 10, so that the flexible sleeve 12 can effectively improve stability of the spring 111 when the spring 111, which is compressed, is placed in the elastic mattress to enable the elastic mattress to have better comfort. Compared with the existing spring mattresses, the elastic mattress of the present disclosure has better comfort.

In one or more embodiments of the present disclosure, referring to FIG. 2 and FIG. 2A at the same time, a thickness h of the base 10 is 5-20 mm. A distance d between two adjacent elastic modules of the plurality of elastic modules 11 is 2-10 mm. Using the above-mentioned size parameters, the sleeving of two elastic modules which belong to different elastic units can be made more stable when different elastic units are sleeved on one another.

In one or more embodiments of the present disclosure, referring to FIG. 5, the spring 111 is a conical spring having better stretching elasticity.

In one or more embodiments of the present disclosure, referring to FIG. 6, an upper part of the spring 111 has a spherical shape, and a lower part of the spring 111 connected to the upper part of the spring 111 has a conical shape. The spring 111 has a larger bottom area since the lower part of the spring 111 is conical, and the spring 111 is more stable when the spring 111 is placed on the base 10. The lower part of the spring 111 having the conical shape has a stronger supporting force, which effectively increases hardness of a waist of the spring 111. The upper part of the spring 111 is spherical so as to be relatively easy to compress to have a good elastic touch feeling, which can partially replace an effect of a high-elastic sponge layer.

### Embodiment 2

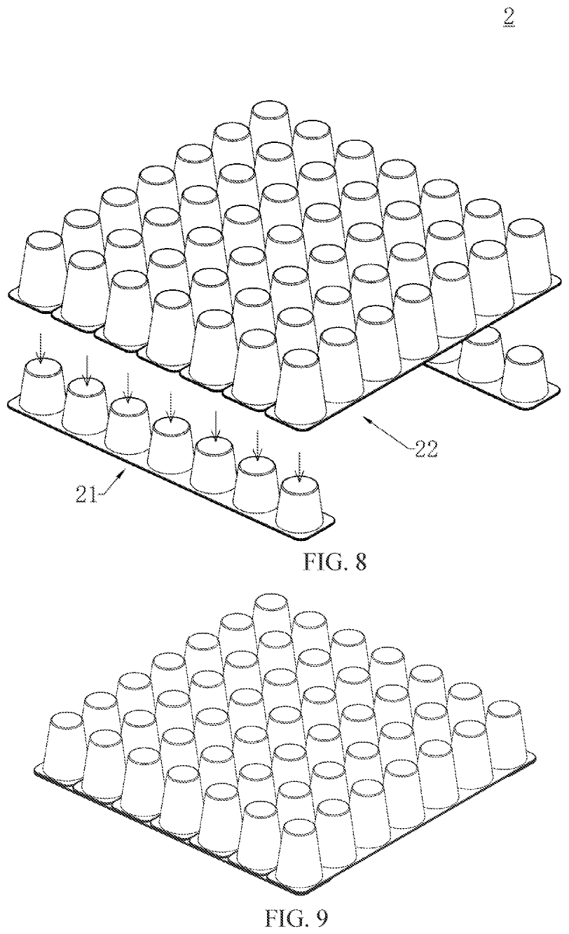

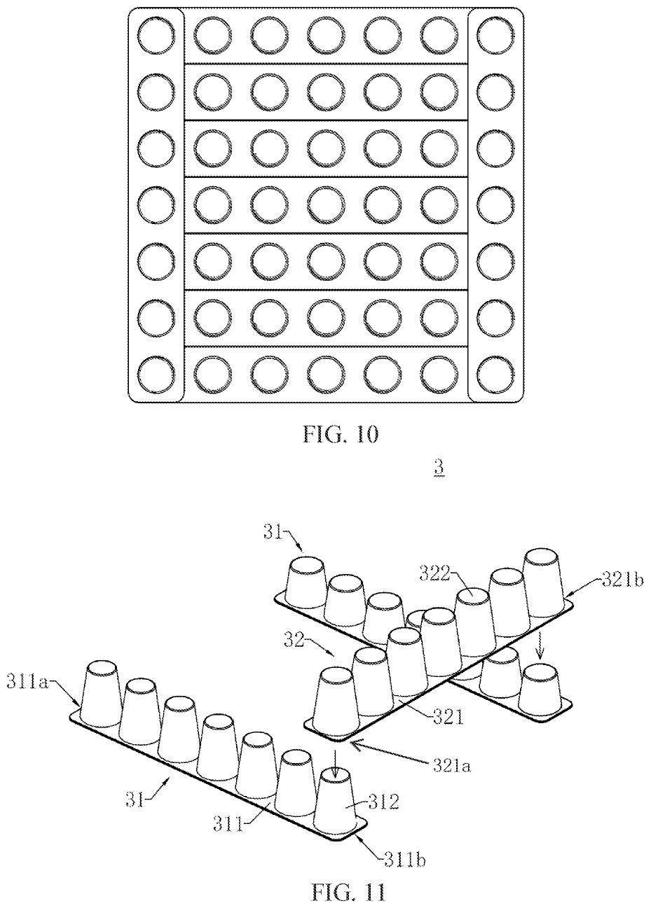

Referring to FIG. 7 to FIG. 10, an elastic assembly 2 of Embodiment 2 of the present disclosure is provided. The elastic assembly 2 comprises two installation units 21 and a plurality of elastic units 22.

The two installation units 21 are configured to be placed symmetrically parallel to each other, and each of the two installation units 21 comprises a positioning base 211. The positioning base 211 comprises a first end 211a and a second end 211b opposite to the first end 211a in a length direction of the positioning base 211. Each of the two installation unit 21 comprises a plurality of positioning assemblies 212 disposed at intervals between the first end 211a and the second end 211b.

A number of the plurality of elastic units 22 is less than or equal to a number of the positioning assemblies 212 of each of the two installation units 21. Each of the plurality of elastic units 22 comprises a base 221. The base 221 comprises a first end 221a and a second end 221b opposite to the first end 221a in a length direction of the base 221, and each of the plurality of elastic units 22 comprises a plurality of elastic modules 222 disposed on the base 221 between the first end 221a and the second end 221b.

The plurality of elastic modules 222 are detachably disposed on the base 221, and each of the plurality of elastic units 22 comprises at least one bottom opening to enable at least one of the plurality of elastic modules 222 to be sleeved on an upper surface of at least one of the plurality of positioning assemblies 212 of a corresponding one of the two installation units 21.

In one or more embodiments of the present disclosure, each of the plurality of elastic modules 222 comprises a spring and a flexible sleeve, and the flexible sleeve comprises a closed end and an open end. The spring is configured to pass through the open end of the flexible sleeve to enter an inside of the flexible sleeve, and the flexible sleeve is wrapped around an outside of the spring. The open end of the flexible sleeve is configured to be detachably connected to a bottom end of the spring, so that the spring has a predetermined initial elastic force by compression. The open end of the flexible sleeve is configured to receive at least one of the plurality of positioning assemblies 212 of the two installation units 21 to enable the plurality of elastic units 22 to be sleeved on the two installation units 21.

In this technical solution, in order to better keep the plurality of elastic modules 222 at a proper position in an elastic mattress, one of the plurality of elastic modules 222 of each of the plurality of elastic units 22 is sleeved on one of the plurality of positioning assemblies 212 of the two installation units 21 so as to achieve fast assembly of the two elements and a neat arrangement of the two elements. In this way, a scattered distribution of the springs can be avoided, where the scattered distribution results in inconsistent elasticity in different regions of the elastic mattress. Not only that, but also the plurality of elastic units 22 are sleeved one by one on the plurality of positioning assemblies 212 of the two installation units 21, thereby forming the elastic mattress having a same level, thereby effectively improving stability of the elastic mattress when the elastic mattress is under pressure, so that the elastic mattress has better comfort.

In particular, on the base 221 of each of the plurality of elastic units 22, a first one of the plurality of elastic modules 222 adjacent to the first end 221a of the base 221 and a second one of the plurality of elastic modules 222 adjacent to the second end 221b of the base 221 are respectively sleeved on a first one of the plurality of positioning assemblies 212 belonging to a first one of the two installation units 21 and a second one of the plurality of positioning assemblies 212 belonging to a second one of the two installation units 21 and opposite to the first one of the plurality of positioning assemblies 212 belonging to the first one of the two installation units 21, so as to enable the plurality of elastic units 22 to be sleeved on the two installation units 21.

In this technical solution, the plurality of elastic units 22 are connected to the two installation units 21 symmetrically parallel to each other, and positions of the plurality of elastic units 22 are fixed to each other. Thus, positions of the plurality of elastic modules 222 located on the base 221 are fixed, so that the elastic mattress has good stability when the elastic mattress is under pressure at any position, and the elastic mattress has better comfort. Due to existence of the two installation units 21, the first one of the plurality of elastic modules 222 adjacent to the first end 221a of the base 221 and the second one of the plurality of elastic modules 222 adjacent to the second end 221b of the base 221 will actually appear higher than the others of the plurality of elastic modules 222 located in a middle of the base 221. Thus, when the elastic assembly 2 is used in the elastic mattress, a user in a sleeping state will be more likely to sleep in a middle area due to a height difference, so as to avoid falling from the elastic mattress.

In one or more embodiments of the present disclosure, referring to FIG. 5, the spring is a conical spring having better stretching elasticity.

In one or more embodiments of the present disclosure, referring to FIG. 6, the spring comprises an upper part and a lower part. The upper part has a spherical shape, and the lower part of the spring connected to the upper part has a conical shape. The spring has a larger bottom area since the lower part of the spring is conical, and the spring is more stable when the spring is placed on the base 221. The conical structure has a stronger supporting force, which effectively increases hardness of a waist of the spring. The upper part is spherical to make the upper part relatively easier to compress and has a good elastic touch feeling, which can partially replace an effect of the high-elastic sponge layer.

### Embodiment 3

Referring to FIG. 11, an elastic assembly 3 of Embodiment 3 of the present disclosure is provided. The elastic assembly 3 comprises two first elastic units 31 and a plurality of second elastic units 32.

The two first elastic units 31 are arranged symmetrically parallel to each other. Each of the two first elastic units 31 comprises a first base 311 comprising a first end 311a and a second end 311b opposite to the first end 311a in a length direction of the first base 311 and a plurality of first elastic modules 312 disposed between the first end 311a and the second end 311b.

Each of the plurality of second elastic units 32 comprises a second base 321 comprising a first end 321a and a second end 321b opposite to the first end 321a in a length direction of the second base 321 and a plurality of second elastic modules 322 disposed between the first end 321a and the second end 321b.

The plurality of the second elastic modules 322 are detachably connected to the second base 321, and each of the plurality of second elastic units 32 comprises at least one bottom opening to enable at least one of the plurality of the second elastic modules 322 to be sleeved on an upper surface of at least one of the plurality of first elastic modules 312 of a corresponding one of the two first elastic units 31.

A number of the plurality of second elastic units 32 is less than or equal to a number of the plurality of first elastic modules 312.

In one or more embodiments of the present disclosure, each of the plurality of first elastic modules 312 comprises a first spring and a first flexible sleeve. The first flexible sleeve has a first closed end and a first open end, and the first spring is configured to pass through the first open end of the first flexible sleeve to enter an inside of the first flexible sleeve to enable the first flexible sleeve to be wrapped around an outside of the first spring. The first open end of the first flexible sleeve is configured to be detachably connected to a bottom end of the first spring, so that the first spring has a predetermined initial elastic force by compression.

Each of the plurality of the second elastic modules 322 comprises a second spring and a second flexible sleeve. The second flexible sleeve has a second closed end and a second open end. The second spring is configured to pass through the second flexible sleeve to enter an inside of the second flexible sleeve so as to enable the second flexible sleeve to be wrapped around an outside of the second spring, and the second open end of the second flexible sleeve is configured to be detachably connected to a bottom end of the second spring, so that the second spring has a predetermined initial elastic force by compression. The second open end can receive a top part of one of the plurality of first elastic modules 312 to form sleeving of the two.

In this technical solution, the two first elastic units 31 and the plurality of second elastic units 32 can be the same elastic unit. Thus, after these elastic units are detached one by one, the elastic units can also be stacked in a nested manner, which can be convenient for disassembly and transport and reduce a space occupied by the elastic mattress. Of course, the two first elastic units 31 and the plurality of second elastic units 32 can also be different elastic units. By adjusting a size of each elastic unit, a size of the assembled elastic mattress can be controlled.

On the second base of each of the plurality of second elastic units 32, a first one of the plurality of second elastic modules 322 adjacent to the first end 321a of the second base 321 and a second one of the plurality of second elastic modules 322 adjacent to the second end 321b of the second base 321 are respectively sleeved on a first one of the plurality of first elastic modules 312 belonging to a first one of the two first elastic units 31 and a second one of the plurality of first elastic modules 312 belonging to a second one of the two first elastic units 31 and opposite to the first one of the plurality of first elastic modules 312 belonging to the first one of the two first elastic units 31, so as to enable the plurality of second elastic units 32 to be sleeved on the two first elastic units 31.

In a more preferred embodiment, the spring is a conical spring for better stretching elasticity.

### Embodiment 4

An elastic mattress configured for furniture of Embodiment 4 of the present disclosure is provided, and the elastic mattress comprises one or more of the elastic units as described in Embodiment 1.

### Embodiment 5

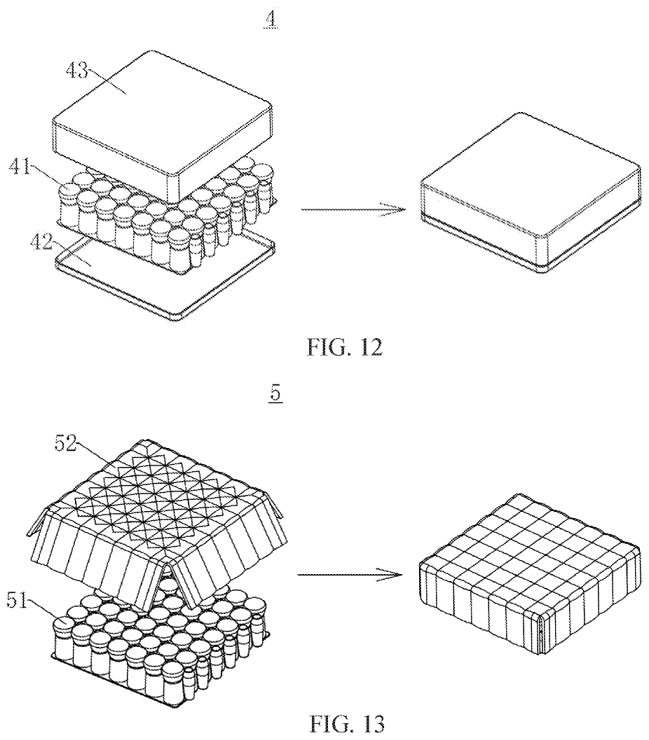

Referring to FIG. 12, an elastic mattress 4 configured for furniture of Embodiment 5 of the present disclosure is provided, and the elastic mattress comprises one or more of the elastic assemblies 41 as described above. The spring used in the one or more of the elastic assemblies 41 comprise an upper part and a lower part, the upper part of the one or more of the elastic assemblies 41 is spherical, and the lower part connected to the upper part is conical.

The elastic mattress 4 comprises a bottom mattress 42 disposed below the one or more of the elastic assemblies 41.

The elastic mattress 4 comprises an outer cover 43 covering an outer surface of the one or more of the elastic assemblies 41.

When in use, the one or more of the elastic assemblies 41 are sleeved on one another, and the one or more of the elastic assemblies 41 are fixedly connected to the bottom mattress 42 by hook-and-loop, bucket structures, etc., and then the outer cover 43 is sleeved on an outside of the one or more of the elastic assemblies 41 and the bottom mattress 42, so the one or more of the elastic assemblies 41, the bottom mattress 42, and the outer cover 43 can be quickly assembled into the elastic mattress 4.

When the elastic mattress 4 is used as a temporary mattress for outdoor camping, student dormitory, an office, or family when guests come, the elastic mattress 4 can better reflect advantages of low cost, easy handling and assembly, and small storage space.

### Embodiment 6

Referring to FIG. 13, an elastic mattress 5 configured for furniture of Embodiment 6 of the present disclosure is provided, and the elastic mattress 5 comprises one or more of the elastic assemblies 51 as described above. The spring used in the one or more of the elastic assemblies 51 comprise an upper part and a lower part. The upper part of the one or more of the elastic assemblies 41 is spherical, and the lower part connected to the upper part is conical.

The elastic mattress 5 comprises an outer cover 52 covering an outer surface of the one or more of the elastic assemblies 51.

When in use, the one or more of the elastic assemblies 51 are sleeved on one another, and the outer cover 52 is sleeved on an outside of the one or more of the elastic assemblies 51, so that the elastic mattress 5 can be quickly assembled.

In addition, those skilled in the art should understand that although there are many problems in the prior art, each embodiment or technical solution of the present disclosure can only be improved in one or several aspects, and it is not necessary to solve all technical problems at the same time listed in the background or in the prior art. It should be understood by those skilled in the art that anything that is not mentioned in a claim should not be taken as a limitation on the claim.

Although terms such as elastic unit, elastic module, base, flexible sleeve, first end, second end, closed end, open end, outer cover, bottom mattress, etc. are used extensively in this article, however, the use of possibility of other terms to describe these components cannot be excluded. These terms are only used to describe and explain the essence of the present disclosure more conveniently, and interpreting them as any kind of additional limitation is against the spirit of the present disclosure. The terms “first”, “second”, etc. in the drawings, if present, are used to distinguish similar items and are not necessarily used to describe a specific order or sequence.

Finally, it should be noted that the above embodiments are only used to illustrate the technical solutions of the present disclosure, rather than limiting them. Although the present disclosure has been described in detail with reference to the foregoing embodiments, those of ordinary skill in the art should understand that it is still possible to modify the technical solutions described in the foregoing embodiments, or perform equivalent replacements for some or all of the technical features, and these modifications or replacements do not make the essence of the corresponding technical solutions deviate from the technical solutions of the various embodiments of the present disclosure.

What is claimed is:

1. An elastic unit, comprising:
a base comprising a first end and a second end opposite to the first end in a length direction of the base; and
a plurality of elastic modules disposed between the first end and the second end of the base, wherein:
the plurality of elastic modules are detachably disposed on the base, and
the elastic unit comprises at least one bottom opening to enable at least one of the plurality of elastic modules to be sleeved on an upper surface of at least one of a plurality of elastic modules of another elastic unit.

2. The elastic unit according to claim 1, wherein:
each of the plurality of elastic modules comprises a spring and a flexible sleeve,
the flexible sleeve comprises a closed end and an open end defining the at least one bottom opening,
the spring is configured to pass through the open end of the flexible sleeve to enter an inside of the flexible sleeve to enable the flexible sleeve to be wrapped around an outside of the spring,
the open end of the flexible sleeve is configured to be detachably connected to a bottom end of the spring to enable the spring to have a predetermined initial elastic force by compression, and
the open end is configured to receive a top part of the at least one of the plurality of elastic modules of the another elastic unit to form sleeving of two elastic modules which belong to different elastic units.

3. The elastic unit according to claim 1, wherein:
a thickness of the base is 5-20 mm, and
a distance between two adjacent elastic modules of the plurality of the elastic modules is 2-10 mm.

4. The elastic unit according to claim 2, wherein the spring is a conical spring.

5. The elastic unit according to claim 2, wherein:
the spring comprises an upper part and a lower part,
the upper part is spherical, and
the lower part is conical.

6. An elastic assembly, comprising:
two installation units, the two installation units being placed symmetrically parallel to each other, each of the two installation units comprising a positioning base, the positioning base comprising a first end and a second end opposite to the first end in a length direction of the positioning base, and each of the two installation units comprising a plurality of positioning assemblies disposed at intervals between the first end of the positioning base and the second end of the positioning base; and
a plurality of elastic units, a number of the elastic units being less than or equal to a number of the plurality of positioning assemblies of each of the two installation units, each of the plurality of elastic units comprising a base, the base comprising a first end and a second end opposite to the first end in a length direction of the base, and each of the plurality of elastic units comprising a plurality of elastic modules disposed between the first end of the base and the second end of the base, wherein:
the plurality of elastic modules are detachably disposed on the base, and
each of the plurality of elastic units comprises at least one bottom opening to enable at least one of the plurality of elastic modules to be sleeved on an upper surface of at least one of the plurality of positioning assemblies of a corresponding one of the two installation units.

7. An elastic assembly, comprising:
two first elastic units, the two first elastic units being configured to be placed symmetrically parallel to each other, each of the two first elastic units comprising a first base, the first base comprising a first end and a second end opposite to the first end in a length direction of the first base, and each of the two first elastic units comprising a plurality of first elastic modules disposed between the first end of the first base and the second end of the first base; and
a plurality of second elastic units, the plurality of second elastic units comprising a second base, the second base comprising a first end and a second end opposite to the first end in a length direction of the second base, and each of the plurality of second elastic units comprising a plurality of second elastic modules disposed between the first end of the second base and the second end of the second base, wherein:
the plurality of the second elastic modules are detachably connected to the second base,
each of the plurality of second elastic units comprises at least one bottom opening to enable at least one of the plurality of the second elastic modules to be sleeved on an upper surface of at least one of the plurality of first elastic modules of a corresponding one of the two first elastic units, and
a number of the plurality of second elastic units is less than or equal to a number of the plurality of first elastic modules.

8. The elastic assembly according to claim 7, wherein:
a first one of the plurality of second elastic modules adjacent to the first end of the second base and a second one of the plurality of second elastic modules adjacent to the second end of the second base are respectively sleeved on a first one of the plurality of first elastic modules belonging to a first one of the two first elastic units and a second one of the plurality of first elastic modules belonging to a second one of the two first elastic units and opposite to the first one of the plurality of first elastic modules belonging to the first one of the two first elastic units, so as to enable the plurality of second elastic units to be sleeved on the two first elastic units.

9. An elastic mattress configured for furniture, wherein:
the elastic mattress comprises one or more of the elastic units according to claim 1.

10. An elastic mattress configured for furniture, wherein:
the elastic mattress comprises one or more of the elastic units according to claim 2.

11. An elastic mattress configured for furniture, wherein:
the elastic mattress comprises one or more of the elastic units according to claim 3.

12. An elastic mattress configured for furniture, wherein:
the elastic mattress comprises one or more of the elastic units according to claim 4.

13. An elastic mattress configured for furniture, wherein:
the elastic mattress comprises one or more of the elastic units according to claim 5.

14. An elastic mattress configured for furniture, wherein:
the elastic mattress comprises one or more of the elastic units according to claim 6.

15. An elastic mattress configured for furniture, wherein:
the elastic mattress comprises one or more of the elastic assemblies according to claim 7, a bottom mattress is disposed below the one or more of the elastic assemblies, and an outer cover covers an outer surface of the one or more of the elastic assemblies.

16. An elastic mattress configured for furniture, wherein:
the elastic mattress comprises one or more of the elastic assemblies according to claim 8, a bottom mattress is disposed below the one or more of the elastic assemblies, and an outer cover covers an outer surface of the one or more of the elastic assemblies.
